(19) United States
(12) Patent Application Publication
(10) Pub. No.: US 2016/0087291 A1
(43) Pub. Date: Mar. 24, 2016

(54) ROTATABLE HEATER OF FUEL CELL SYSTEM AND CONTROL METHOD THEREOF

(71) Applicant: HYUNDAI MOTOR COMPANY, Seoul (KR)

(72) Inventors: Su-Dong HAN, Suwon-si (KR); Hyung Kook KIM, Seongnam-si (KR)

(73) Assignee: HYUNDAI MOTOR COMPANY

(21) Appl. No.: 14/550,759

(22) Filed: Nov. 21, 2014

(30) Foreign Application Priority Data
Sep. 22, 2014 (KR) 10-2014-0126190

(51) Int. Cl. H01M 8/04

(52) U.S. Cl. CPC H01M 8/04268; H01M 8/04037; H01M 2250/20

(57) ABSTRACT

A rotatable heater of a fuel cell system includes a heater housing, into and out of which a coolant for cooling a fuel cell stack flows, and which defines a coolant chamber therein. A motor is driven by an electrical energy generated from the fuel cell stack or by another power source. At least one heater stick generates heat by the electrical energy generated by the fuel cell stack and heats the coolant. The at least one heater stick rotates by the motor.

### CROSS-REFERENCE TO RELATED APPLICATION

The present application claims the benefit of priority to Korean Patent Application Number 10-2014-0126190 filed on Sep. 22, 2014, the entire contents of which application are incorporated herein for all purposes by this reference.

### TECHNICAL FIELD

The present disclosure relates to a heater for a fuel cell system, and more particularly, to a rotatable heater for a fuel cell system and a control method thereof.

### BACKGROUND

As is known in the art, a fuel cell system receives hydrogen as a fuel and oxygen in the air and generates electrical energy by an electrochemical reaction between the hydrogen and the oxygen in a fuel cell.

The fuel cell system generally includes a fuel cell stack for generating the electrical energy, a fuel supply system for supplying the fuel (hydrogen) to the fuel cell stack, an air supply system for supplying the oxygen as an oxidant which is required for the electrochemical reaction to the fuel cell stack, and a thermal management system for controlling an operating temperature of the fuel cell stack.

The thermal management system of the fuel cell stack includes a cooling system connecting a pump, a heater, and the stack in series.

For a conventional fuel cell vehicle, a coolant for cooling the fuel cell stack can be used as antifreeze for a cold start. In this case, a heater is required to heat the coolant. The heater may have a cathode oxygen depletion (COD) function.

Accordingly, the heater with the COD function can improve durability of a fuel cell by performing the COD function to convert electrical energy from the fuel cell stack into thermal energy during startup and shutdown of the fuel cell vehicle, and improve cold start performance by quickly heating the coolant during the cold start of the vehicle to raise a temperature of the fuel cell stack.

However, the conventional in-series structure of the pump, heater with the COD function, and stack may decrease a stack voltage at the time of cold start due to an inflow of low-temperature coolant or overcooling of the stack.

As the pump becomes inoperative due to the stack voltage drop, the coolant does not circulate through the cooling system for the fuel cell stack, and as a result, the heater with the COD function also becomes inoperative. This is because, when operating the heater while the coolant does not circulate, the heater is cooled by only a natural convention of the coolant, thus forming bubbles on a surface of the heater. Accordingly, the heater may not operate properly due to a high temperature.

The heater and the pump do not consume the electrical energy from the fuel cell stack, thus no heat is generated by the stack.

The overcooled fuel cell stack generates heat by itself by supplying the electrical energy to the pump, the heater, and other load devices at the time of cold start. Accordingly, coolant circulation does not occur at the cold start, and the heater with the COD function becomes inoperative. Thus, other methods may be used to generate heat in the stack, which may increase the cold start time.

Moreover, as the coolant does not circulate, the heater still remains to be inoperative under different vehicle states.

The above information disclosed in this Background section is only for enhancement of understanding of the background of the disclosure, and therefore, it may contain information that does not form the prior art that is already known in this country to a person of ordinary skill in the art.

### SUMMARY

The present disclosure has been made in an effort to provide a heater which generates heat as an electrical energy of a fuel cell stack for a fuel cell vehicle even when a coolant for cooling the stack does not circulate.

According to an exemplary embodiment of the present inventive concept, a rotatable heater of a fuel cell system includes a heater housing, into and out of which a coolant for cooling a fuel cell stack flows, and which defines a coolant chamber therein. A motor is driven by an electrical energy generated from the fuel cell stack or by another power source. At least one heater stick generates heat by the electrical energy generated by the fuel cell stack and heats the coolant. The at least one heater stick rotates by the motor.

The rotatable heater may further include a heater plate that has the at least one heater stick mounted on one surface and rotates with the motor.

The rotatable heater may further comprise at least one heat release fin that is coupled to the entire or each of the at least one heater stick.

The at least one heat release fin may be tilted at an angle in a length direction of the at least one heater stick.

The rotatable heater may further include a coolant reservoir that collects fine bubbles generated in the heater housing and temporarily stores or releases the fine bubbles.

The motor may allow the at least one heater stick to rotate in both clockwise and counterclockwise directions.

According to an exemplary embodiment of the present inventive concept, a control method of a rotatable heater of a fuel cell system, which comprises a heater housing, into and out of which a coolant for cooling a fuel cell stack flows, and which defines a coolant chamber therein; a motor that is driven by an electrical energy generated from the fuel cell stack or by another power source;

at least one heater stick that generates heat by the electrical energy generated by the fuel cell stack and heats the coolant; a coolant temperature sensor for measuring a coolant temperature of the fuel cell stack; and a controller configured to determine a rotational time of the motor and to control a rotational direction and speed of the motor, and the at least one heater stick rotating by using the motor, includes determining whether the coolant temperature is equal to or below a first set temperature by the controller. Heat is generated from the at least one heater stick, and the motor is periodically rotates in both clockwise and counterclockwise directions by the controller if the coolant temperature is equal to or below the first set temperature.

The control method may further include at least one of determining a maximum rotational speed of the motor by the controller, and determining a period of the bidirectional rotation of the motor by the controller.

The control method may further include determining a maximum angle of the bidirectional rotation of the motor by the controller.

The control method may further include determining whether the coolant temperature exceeds a second set temperature by the controller. The bidirectional rotation of the motor is terminated by the controller if the coolant to temperature exceeds the second set temperature.

The rotatable heater may further comprise an air temperature sensor for measuring an air temperature of an outlet of the fuel cell stack. The control method of the rotatable heater may further include determining whether the air temperature of the fuel cell stack exceeds a third set temperature by the controller. The bidirectional rotation of the motor is terminated by the controller if the outlet air temperature of the fuel cell stack exceeds the third set temperature.

### BRIEF DESCRIPTION OF THE DRAWINGS

FIG. 1 is a view showing a series structure of a pump, a rotatable heater with a COD function, and a stack according to an exemplary embodiment of the present inventive concept.

FIGS. 2A-2C are views showing a structure where a plurality of heat release fins are mounted on the rotatable heater according to an exemplary embodiment of the present inventive concept.

FIG. 3 is a view showing a bidirectional rotation of the rotatable heater according to an exemplary embodiment of the present inventive concept.

FIG. 4 is a block diagram of a control apparatus of the rotatable heater according to an exemplary embodiment of the present inventive concept.

FIG. 5 is a flowchart showing one example of a control method of the rotatable heater according to an exemplary embodiment of the present invention.

### DETAILED DESCRIPTION

Hereinafter, exemplary embodiments of the present inventive concept will be described in detail with reference to the accompanying drawings so that those of ordinary skill in the art easily carry out the present inventive concept.

These exemplary embodiments are examples of the present inventive concept. One skilled in the art will recognize that the present inventive concept may be implemented in various different forms and should not be construed as being limited to the embodiments described herein.

In the specification, unless explicitly described to the contrary, the word “comprise” and variations such as “comprises” or “comprising” will be understood to imply the inclusion of stated elements but not the exclusion of any other element.

The names of constituent elements do not define or limit their functions.

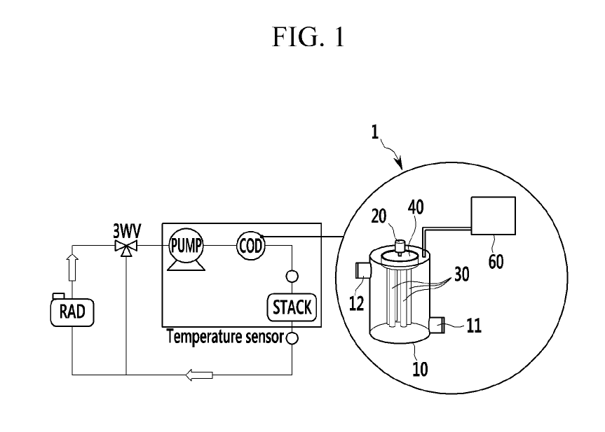

FIG. 1 is a view showing a series structure of a pump, a rotatable heater with a COD function, and a stack according to an exemplary embodiment of the present inventive concept.

As depicted in FIG. 1, the series structure of the pump, the rotatable heater with the COD function, and the stack forms a closed loop, and a coolant for cooling the stack circulates in an arrow direction. The coolant is heated by heat generated from the stack and is cooled at a radiator. A coolant line may include a reservoir to refill the coolant and to remove air bubble.

Referring to the enlarged view of the rotatable heater with the COD function of FIG. 1, the rotatable heater 1 according to an exemplary embodiment of the present inventive concept may include a heater housing 10, a motor 20, and at least one heater stick 30.

The coolant for cooling the fuel cell stack flows in and out of the heater housing 10, and a coolant chamber (not shown) is defined within the heater housing 10.

A coolant inlet 11 and a coolant outlet 12 are formed or mounted on the heater housing 10.

The motor 20 may be driven by the electrical energy generated from the fuel cell stack or by a power source. In exemplary embodiments, the motor 20 is driven by the power source (not shown). This is because the at least one heater stick 30 has to consume the electrical energy of the fuel cell stack in order for the rotatable heater 1 to allow the fuel cell stack to generate heat while performing the COD function.

Both the motor 20 and the at least one heater stick 30 may be powered by the electrical energy of the fuel cell stack. The at least one heater stick 30 generates heat by the electrical energy generated from the fuel cell stack and heats the coolant within the heater housing 10. That is, the at least one heater stick 30 in the heater 1 consumes the electrical energy of the fuel cell stack. As such, the fuel cell stack generates heat by a load of the at least one heater stick 30.

Accordingly, the fuel cell stack can quickly go back to a normal temperature when overcooled.

The rotatable heater 1 according to the exemplary embodiment of the present inventive concept rotates the at least one heater stick 30 with the motor 20 in a clockwise or counterclockwise direction.

As the at least one heater stick 30 can rotate in both directions, the heat release by convention can be obtained even when the coolant for cooling the fuel cell stack does not circulate. Moreover, the bidirectional rotation can eliminate low-heat transfer regions that may be formed on the heat stick 30. In addition, the at least one heater stick 30 may rotate in both directions periodically.

Accordingly, the direction of rotation of at least one heater stick 30 may be changed periodically with respect to a rotational axis. Further, a heat transfer rate of the heater stick 30 can be adjusted by controlling a rotational speed. When the rotational speed increases, heat can be released more efficiently from the heater stick 30.

The rotatable heater 1 according to the exemplary embodiment of the present inventive concept may further include a heater plate 40 that has the at least one heater stick 30 mounted on one surface and rotates with the motor 20.

In the exemplary embodiment of FIG. 1, the motor 20 rotates the plurality of heater sticks 30 mounted on a bottom surface of the heater plate 40 while rotating the heater plate 40.

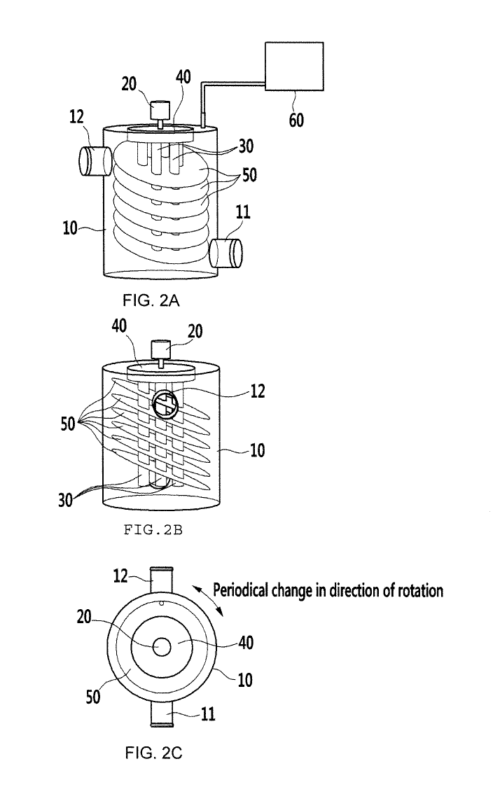

FIGS. 2(a)-2(c) are views showing a structure where a plurality of heat release fins are mounted on the rotatable heater according to the exemplary embodiment of the present inventive concept.

Referring to FIGS. 2(a)-2(c), the rotatable heater 1 according to the exemplary embodiment of the present inventive concept may further include at least one heat release fin 50 that is formed or mounted on the entire or a part of the at least one heater stick 30.

The at least one heat release fin 50 may be formed or mounted in such a way that it is tilted at an angle in a length direction of the at least one heater stick 30.

FIGS. 2(a)-2(c) show circular heat release fins 50 making contact with each of the heater sticks 30 and connecting them to each other are suggested.

When the heater plate 40 periodically rotates in both directions, if the heat release fins 50 are tilted at an angle in a length direction of the heater sticks 30, a temperature of the coolant within the heater housing 10 becomes more uniform, and therefore, heat is more efficiently released from the heater sticks 30.

Referring to FIG. 2(a), the rotatable heater 1 according to the exemplary embodiment of the present inventive concept may further include a coolant reservoir 60 that collects fine bubbles generated in the heater housing 10 and temporarily stores or releases them.

FIG. 2(c) is a top plan view of the heater 1, which illustrates the heater plate 40 and the heat release fins 50 periodically changing the direction of rotation. A rubber gasket (not shown) for sealing against coolant during rotation of the heater plate 40 may be mounted between the heater plate 40 and the heater housing 10.

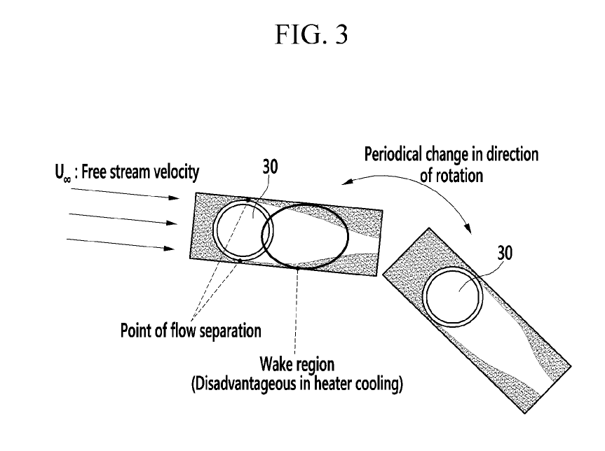

FIG. 3 is a view showing a bidirectional rotation of the rotatable heater according to the exemplary embodiment of the present inventive concept. U_{∞} is a free stream velocity of coolant moving past rotating heater sticks 30. FIG. 3 illustrates a bottom side of two heater sticks 30 rotating in a counterclockwise direction.

Referring to FIG. 3, the coolant does not contact rear end surfaces of the rotating heater sticks 30 due to flow separation, which makes heat transfer difficult. Accordingly, the surfaces of the heater sticks 30 are hardly cooled, and thus may be easily overheated. This may cause an adverse effect on the durability of the heater 1 according to the exemplary embodiment of the present inventive concept.

However, since the heater 1 can periodically rotate the heater sticks in both clockwise and counterclockwise directions, the direction of flow separation of the coolant is reversed as the rotational direction changes. Accordingly, separation surfaces of the heater sticks 30 shift back and forth, thus uniformly cooling the surfaces of the heater sticks 30, thus preventing the heater sticks 30 from overheating.

Therefore, using the rotatable heater 1 according to the exemplary embodiment of the present inventive concept, cold start performance can be improved, and destruction of the heater sticks 30 can be prevented.

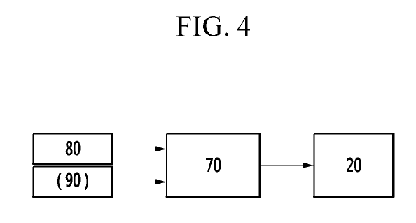

FIG. 4 is a block diagram of a control apparatus of a rotatable heater according to an exemplary embodiment of the present inventive concept.

The control apparatus of the rotatable heater 1 according to the exemplary embodiment of the present inventive concept further includes a controller 70, a coolant temperature sensor 80 for measuring a temperature of a coolant for a fuel cell stack, and the motor 20 for rotating the at least one heater stick 30.

The controller 70 may determine a rotational time of the motor 20 according to the temperature of the coolant measured by the coolant temperature sensor 80 and control a rotational direction and speed of the motor 20.

The controller 70 may receive a temperature signal from the coolant temperature sensor 80, control according to a predetermined control logic, and control the bidirectional rotation of the heater 1 by sending an output signal to the motor 20.

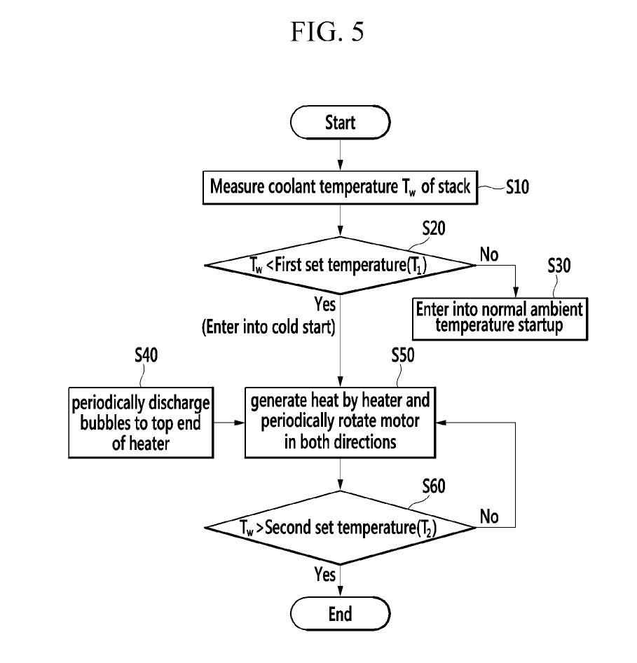

FIG. 5 is a flowchart showing one example of a control method of a rotatable heater according to an exemplary embodiment of the present inventive concept.

The control method of the rotatable heater 1 according to the exemplary embodiment of the present inventive concept may include measuring a temperature T_{W} of a coolant for a fuel cell stack by the cooling water temperature sensor 80 upon starting at step S10. Whether a coolant temperature is equal to or below a first set temperature T₁ is determined by the controller 70 at step S20. Heat is generated from the at least one heater stick 30 and the motor 20 periodically rotates in clockwise and clockwise directions by the controller 70 at step S50 if the coolant temperature is equal to or below the first set temperature,.

In step S50, the controller 70 may determine a maximum rotational speed of the motor 20 or a period of bidirectional rotation of the motor 20 in advance according to the coolant temperature.

Alternatively, step S50 may be performed by determining a maximum angle of the bidirectional rotation of the motor 20 in advance. When the motor 20 rotates in both directions in step S50, bubbles formed in the coolant may be periodically discharged to a top end of the heater 1. The bubbles to be discharged may be collected by the coolant reservoir 60 and temporarily stored or released to outside.

Moreover, the control method of the rotatable heater 1 may include entering into a normal ambient temperature startup if the coolant temperature T_{W} of the stack exceeds the first set temperature T₁ in step S30.

In addition, the control method of the heater 1 may further include determining whether the coolant temperature T_{W} of the stack exceeds a second set temperature T₂ in step S60.

The heat generation and bidirectional rotation of the heater 1 continue while the coolant temperature T_{W} is maintained equal to or less than the second set temperature T₂. If T_{W} exceeds T₂, the heat generation and bidirectional rotation of the heater 1, that is, the cold start step S50, can be completed by the controller 70. Step S60 may be performed by determining whether an outlet air temperature of the fuel cell stack exceeds a reference temperature (third set temperature).

In this case, the control apparatus of the rotatable heater 1 according to the exemplary embodiment of the present inventive concept may further include an air temperature sensor 90 (see FIG. 4). The air temperature sensor 90 may be mounted at an outlet of the stack. If the outlet air temperature of the stack exceeds the third set temperature, the cold start step S50 is completed.

As described above, according to the present invention, startup performance can be improved since the heater can generate heat by the electrical energy of the fuel cell stack even when the coolant does not circulate.

While this inventive concept has been described in connection with what is presently considered to be practical exemplary embodiments, it is to be understood that the invention is not limited to the disclosed embodiments.

On the contrary, it is intended to cover various modifications and equivalent arrangements included within the spirit and scope of the appended claims.

What is claimed is:

1. A rotatable heater of a fuel cell system, comprising:
a heater housing, into and out of which a coolant for cooling a fuel cell stack flows, and which defines a coolant chamber therein;
a motor that is driven by an electrical energy generated from the fuel cell stack or by another power source; and
at least one heater stick that generates heat by the electrical energy generated by the fuel cell stack and heats the coolant,
wherein the at least one heater stick rotates by the motor.

2. The rotatable heater of claim 1, further comprising a heater plate that has the at least one heater stick mounted on one surface thereof and rotates with the motor.

3. The rotatable heater of claim 1, further comprising at least one heat release fin coupled to the entire or each of the at least one heater stick.

4. The rotatable heater of claim 3, wherein the at least one heat release fin is tilted at an angle in a length direction of the at least one heater stick.

5. The rotatable heater of claim 1, further comprising a coolant reservoir that collects fine bubbles generated in the heater housing and temporarily stores or releases the fine bubbles.

6. The rotatable heater of claim 1, wherein the motor allows the at least one heater stick to rotate in both clockwise and counterclockwise directions.

7. A control method of a rotatable heater of a fuel cell system, wherein the rotatable heater comprising:
a heater housing, into and out of which a coolant for cooling a fuel cell stack flows, and which defines a coolant chamber therein;
a motor that is driven by an electrical energy generated from the fuel cell stack or by another power source;
at least one heater stick that generates heat by the electrical energy generated by the fuel cell stack and heats the coolant and rotates by the motor;
a coolant temperature sensor for measuring a coolant temperature of the fuel cell stack; and
a controller configured to determine a rotational time of the motor and to control a rotational direction and speed of the motor,
the method comprising steps of:
determining, by the controller, whether the coolant temperature is equal to or below a first set temperature; and
generating, by the controller, the heat from the at least one heater stick and periodically rotating the motor in both clockwise and counterclockwise directions if the coolant temperature is equal to or below the first set temperature.

8. The control method of claim 7, further comprising at least one of two steps of:
determining, by the controller, a maximum rotational speed of the motor; and
determining, by the controller, a period of the bidirectional rotation of the motor.

9. The control method of claim 7, further comprising a step of: determining a maximum angle of the bidirectional rotation of the motor by the controller in both clockwise and counterclockwise directions.

10. The control method of claim 7, further comprising steps of:
determining, by the controller, whether the coolant temperature exceeds a second set temperature; and
terminating the bidirectional rotation of the motor by the controller if the coolant temperature exceeds the second set temperature.

11. The control method of claim 7, wherein
the rotatable heater further comprises an air temperature sensor for measuring an air temperature of an outlet of the fuel cell stack, and
the control method of the rotatable heater further comprises steps of:
determining, by the controller, whether the air temperature of the outlet of the fuel cell stack exceeds a third set temperature; and
terminating the bidirectional rotation of the motor by the controller if the air temperature of the outlet of the fuel cell stack exceeds the third set temperature.

12. A non-transitory computer-readable recording medium comprising computer executable instructions execution of which causes the controller to perform the method according to claim 7.
